(19) United States
(12) Patent Application Publication
(10) Pub. No.: US 2012/0021374 A1
(43) Pub. Date: Jan. 26, 2012

(54) OSCILLATING SPRAY TIP FOR ORAL IRRIGATOR

(75) Inventors: Joseph W. Cacka, Berthoud, CO (US); Kenneth A. Hair, Fort Collins, CO (US)

(73) Assignee: Water Pik, Inc., Fort Collins, CO (US)

(21) Appl. No.: 13/188,410

(22) Filed: Jul. 21, 2011

Related U.S. Application Data
(60) Provisional application No. 61/367,263, filed on Jul. 23, 2010.

(51) Int. Cl. A61C 17/02

(52) U.S. Cl. 433/82

(57) ABSTRACT

An oral irrigator tip defines a main fluid passage and first and second side fluid passages on a opposite sides of the main fluid passage. Each side fluid passage has an inlet and an outlet both in fluid communication with the main fluid passage. First and second island structures may be formed between the main fluid passage and respective side fluid passages. Fluid flow through the main fluid passage is drawn to sidewalls of the islands due to the Coanda effect. At least a portion of the fluid stream entering the main fluid passage is diverted through the first and second side fluid passages to create feedback loops that push the fluid flow through the main fluid passage alternately from side to side. An oscillating fluid stream is thereby delivered from the oral irrigator tip.

### CROSS REFERENCE TO RELATED APPLICATIONS

This application claims the benefit of priority pursuant to 35 U.S.C. §119(e) of U.S. provisional application No. 61/367,263 filed 23 Jul. 2010 entitled “Oscillating Spray Tip for Oral Irrigator,” which is hereby incorporated herein by reference in its entirety.

### TECHNICAL FIELD

The present invention relates generally to dental hygiene, and more particularly to a jet tip for an oral irrigator device.

### BACKGROUND

Oral irrigators have become more and more prevalent in daily hygiene routines. Oral irrigators may direct water, medicament, or other fluids against teeth and gums and into interproximal spaces, thus cleaning such areas as well as aiding in removing plaque and strengthening teeth and maintaining or improving oral health. An exemplary oral irrigator device is described in is application is related to U.S. Patent Application Publication No. 2007/0203439 en titled “Water jet unit and handle,” which is hereby incorporated by reference herein in its entirety.

The information included in this Background section of the specification, including any references cited herein and any description or discussion thereof, is included for technical reference purposes only and is not to be regarded subject matter by which the scope of the invention is to be bound.

### SUMMARY

The present invention is an oral irrigator tip that provides an oscillating fluid stream for dental and oral cleaning by a user. An oral irrigator tip defines a main fluid passage and first and second side fluid passages on a opposite sides of the main fluid passage. Each side fluid passage has an inlet and an outlet both in fluid communication with the main fluid passage. First and second island structures may be formed between the main fluid passage and respective side fluid passages. Fluid flow through the main fluid passage is drawn to sidewalls of the islands due to the Coanda effect. At least a portion of the fluid stream entering the main fluid passage is diverted through the first and second side fluid passages to create feedback loops that push the fluid flow through the main fluid passage alternately from side to side. An oscillating fluid stream is thereby delivered from the oral irrigator tip. The invention may be realized by a number of different implementations as described herein and further combinations thereof.

In one embodiment, an oral irrigator tip has a shaft portion and a tip portion. The shaft portion defines a fluid passage. The tip portion defines a main fluid passage in fluid communication with the fluid passage defined in the shaft portion. The tip portion also defines a first side fluid passage on a first side of the main fluid passage. The first side fluid passage has a first inlet and a first outlet both in fluid communication with the main fluid passage. The tip portion further defines a second side fluid passage on a second side of the main fluid passage. The second side fluid passage has a second inlet and a second outlet both in fluid communication with the main fluid passage. At least a portion of the fluid stream entering the main fluid passage through the shaft portion is diverted to the first and second side fluid passages so as to deliver an oscillating fluid stream from the oral irrigator tip.

Another implementation of an oral irrigator tip has a shaft portion that defines a fluid passage and a tip portion. The tip portion defines a main fluid passage in fluid communication with the fluid passage defined in the shaft portion. The tip portion also defines a first island on a first side of the main fluid passage and a second island on a second side of the main fluid passage. The first island defines a first angled sidewall adjacent the main fluid passage and the second island defines a second angled sidewall adjacent the main fluid passage. At least a portion of a fluid stream entering the tip portion from the fluid passage of the shaft portion is caused to circulate around the first island and the second island.

In a further implementation, an oral irrigator tip insert has an inlet and a main channel in fluid communication with the inlet. The tip insert further defines a structure configured to cause a Coanda effect on fluid flow through the main channel. The tip insert also defines a pair of feedback loops that divert fluid from the main channel at a first end and redirect the diverted fluid into the main channel at a second end. The tip insert also has an outlet through which oscillating fluid flow exits the tip insert.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

FIG. 1 is an isometric view of an exemplary an oral irrigator having a base housing a pump and a reservoir, a handle connected to the base, and an oral irrigator tip connected to the end of the handle.

FIG. 2 is an isometric view of the oral irrigator tip shown in FIG. 1.

FIG. 3 is a front elevation view of a portion of the oral irrigator tip of FIG. 2.

FIG. 4 is a side elevation view of a portion of the oral irrigator tip of FIG. 2.

FIG. 5 is side elevation view in cross-section of the portion of the oral irrigator tip of FIG. 3 as viewed along line 5-5 in FIG. 3.

FIG. 6 is a top plan view in cross-section of the portion of the oral irrigator tip of FIG. 4 as viewed along line 6-6 of FIG. 4.

FIG. 7A is a bottom plan view in cross-section of a portion of the oral irrigator tip of FIG. 2, viewed along line 7A-7A in FIG. 5.

FIG. 7B is a top plan view in cross-section of a portion of the oral irrigator tip of FIG. 2, viewed along line 7B-7B in FIG. 5.

FIG. 8 is an isometric view from the bottom, left, front of a tip insert for the oral irrigator tip of FIG. 2.

FIG. 9 is an isometric view from the bottom, right, rear of the tip insert of FIG. 8.

FIG. 10 is an exploded isometric view of a portion of the oral irrigator tip of FIG. 2.

FIG. 11 is a rear elevation view of the tip insert of FIG. 8.

FIG. 12 is a top plan view of the tip insert of FIG. 8.

FIG. 13 is a front elevation view of the tip insert of FIG. 8.

FIG. 14 is a bottom plan view of the tip insert of FIG. 8.

### DETAILED DESCRIPTION OF THE INVENTION

An oral irrigator tip 110 for an oral irrigator 100 is disclosed. In some implementations, the oral irrigator tip 110 may be of unitary construction and in other implementations it may be assembled from multiple components. The oral irrigator tip 110 may include a tip portion 128 joined to a shaft portion 126. The shaft portion 126 may include a retaining feature 132 that may be used to join the oral irrigator tip 110 to an oral irrigator handle 120. The tip portion 128 may be removably or fixedly joined to the shaft portion 126. The shaft portion 126 may include a fluid inlet 130 fluidly communicating with a fluid reservoir of an oral irrigator 100 and a fluid passage 150 for conveying fluid from a base 122 to an apex 136 of the shaft portion 126. The shaft portion 126 may further include a fluid outlet 152 fluidly joined to a fluid inlet 153 of the tip portion 128. The tip portion 128 may include a fluid outlet 158 for delivering a fluid stream from the oral irrigator tip 110. Fluid exiting the tip portion 128 may be used to irrigate, or otherwise clean, a user's mouth.

The tip portion 128 may include a tip receiver 138 and a tip insert 140. Collectively the tip receiver 138 and tip insert 140 may define multiple fluid passages that join the fluid inlet 153 to the fluid outlet 158 of the tip portion 128. In one embodiment, the tip insert 140 may define a main fluid passage 162 and two side fluid passages 166a/b on each side of the main fluid passage 162. At least a portion of the fluid flowing through the main fluid passage 162 may be diverted to the two side fluid passages 166a/b so that the tip portion 128 may deliver an oscillating stream of fluid from the fluid outlet 158 as further described below. Such an oscillating fluid stream may enhance removal of plaque from a user's teeth.

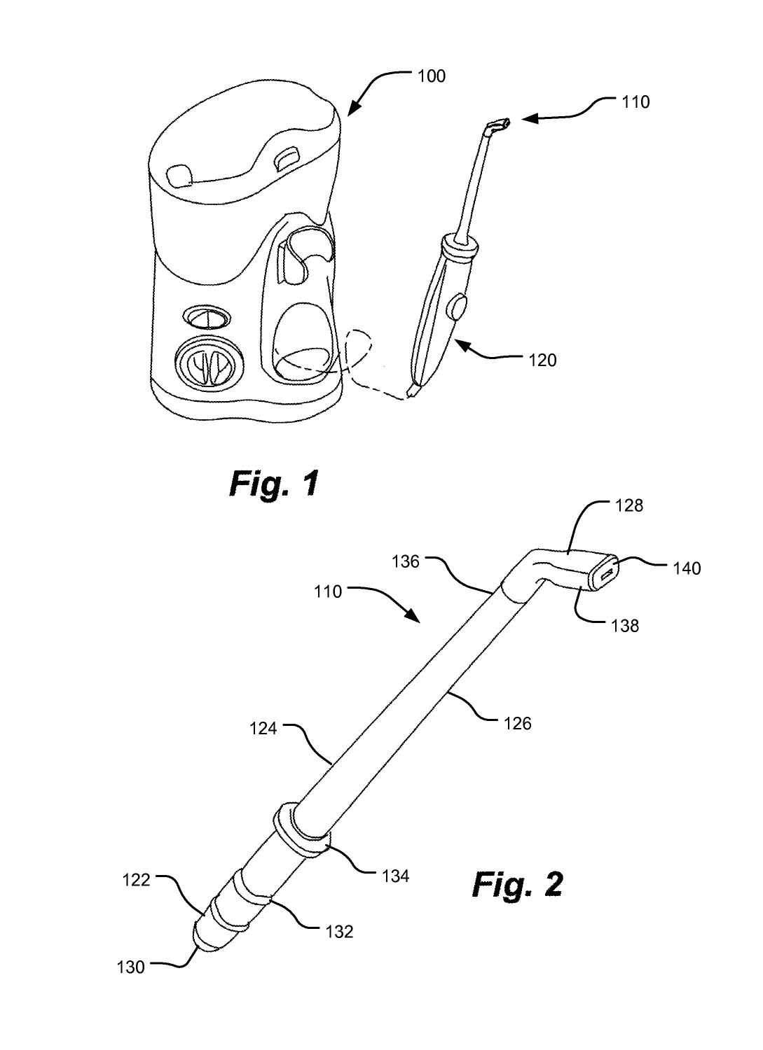

FIG. 1 depicts an exemplary oral irrigator 100 joined to an oral irrigator tip 110. The oral irrigator 100 may take the form as depicted in FIG. 1, as depicted or described in U.S. Patent Application Publication No. 2007/0203439, or any other suitable form. Generally, the oral irrigator 100 may include a reservoir for holding a fluid, such as water, in fluid communication with a pump contained within a housing of the oral irrigator 100. The pump conveys fluid from the reservoir to an oral irrigator handle 120 in fluid communication with the pump. An oral irrigator tip 110 may be attached to the oral irrigator handle 120 to deliver a fluid stream from the oral irrigator tip 110. The fluid stream may be used to clean the teeth of a user, or to provide other dental hygiene functions.

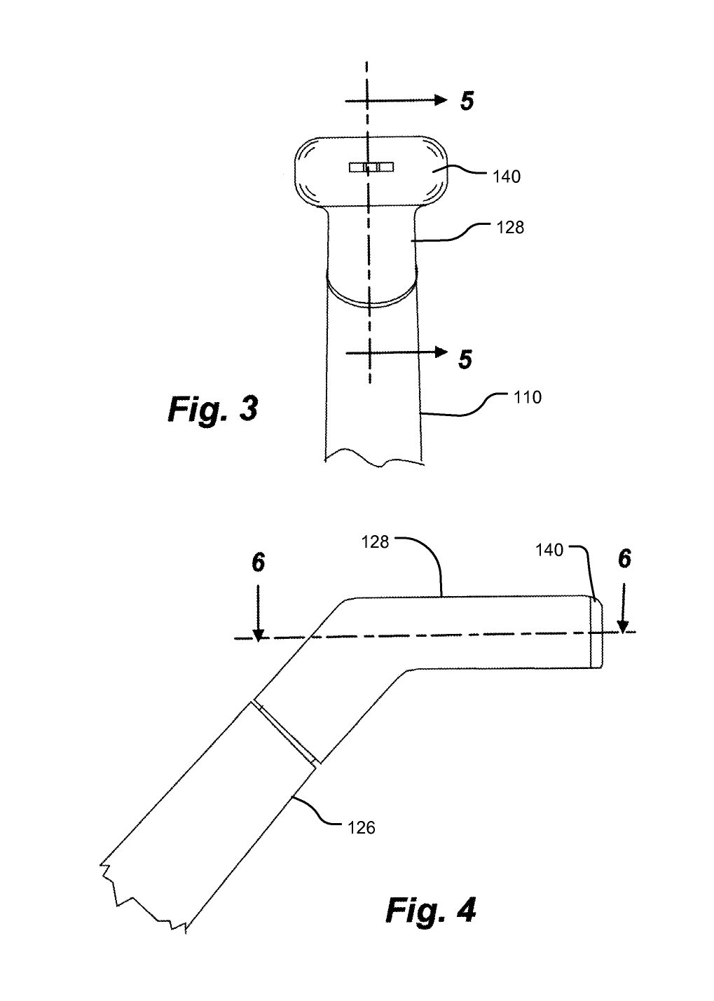

Generally, one embodiment of the oral irrigator tip 110 may take the form of a shaft portion 126 joined to a tip portion 128, or other fluid outlet element or assembly of components, as shown, for example, in FIGS. 2-4. The shaft portion 126 and tip portion 128 may be formed from plastic, metal, ceramics, or other rigid or semi-rigid materials. The shaft portion 126 may have a base 122 at one end, an apex 136 at another end, and a transitional portion 124 extending from the base 122 to the apex 136.

The shaft portion 126 may be straight as shown, for example, in FIG. 2, or an angle may be formed at some point along the shaft portion 126. If the shaft portion 126 includes an angle, the angle may be formed in the transitional portion 124 or the apex 136. The angle may be formed by heat softening a straight shaft portion 126 in the area to be angled and then bending the heat-softened portion into the desired angle or shape, by forming the shaft portion 126 in a mold of the desired bent shape, by joining a bent component to a straight component, or by other appropriate methods.

The shaft portion 126 is typically hollow from a fluid inlet 130, which may be defined in or proximate the base 122, to a fluid outlet 152, which may be defined in or proximate the apex 136, to form a fluid passage 150 within the shaft portion 126. The shaft fluid inlet 130 may be fluidly connected to an oral irrigator fluid outlet, such as a fluid outlet in the handle 120, and the shaft fluid outlet 152 may be in fluid communication with a tip portion fluid inlet 153, thus permitting fluid to flow through the shaft portion 126 from the oral irrigator 100 to the tip portion 128.

A retaining feature 132 may be formed on the shaft portion 126, for example, as shown in FIGS. 2-4. The retaining feature 132 generally permits the oral irrigator tip 110 to be mated to, and retained in, the oral irrigator handle 120. The retaining feature 132 may take the form of an annular groove formed about the transitional portion 124 near the base 122. The oral irrigator tip 110 may be mated to the oral irrigator handle 120, for example, by receiving a shelf or protuberance within the oral irrigator handle 120 as described, for example, in U.S. Patent Application Publication No. 2007/0203439, within the annular groove. Alternatively, the retaining feature 132 may be a projection that seats within a groove or depression formed within the oral irrigator handle 120 to connect the oral irrigator tip 110 to the oral irrigator handle 120.

An anti-rotation feature 134 may be formed on the shaft portion 126 to limit rotation of the oral irrigator tip 110 relative to the handle 120 about a longitudinal axis of the shaft portion 126 when the oral irrigator tip 110 is coupled to the oral irrigator handle 120. The anti-rotation feature 134 may take the form of a flange extending from the shaft portion 126 and configured for receipt within a recess formed in the oral irrigator handle 120. The flange may be a polygon or other non-circular shape and the handle recess may define a similar shape to prevent rotation of the flange within the handle recess and thus prevent rotation of the oral irrigator tip 110 relative to the handle 120 about the longitudinal axis of the oral irrigator tip 110.

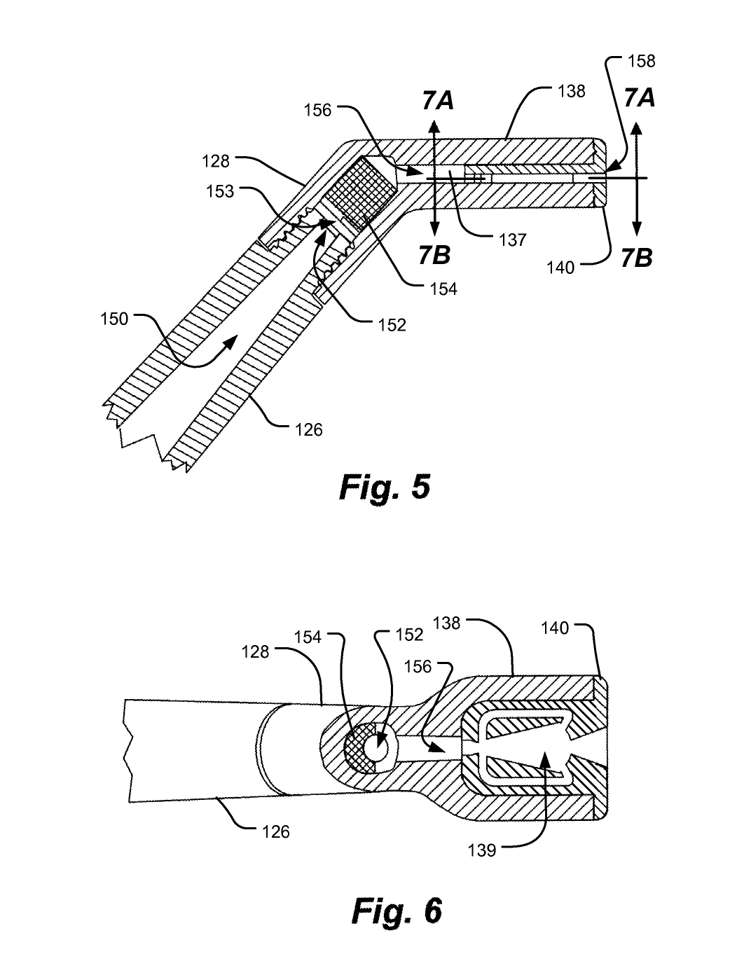

As depicted, for example, in FIGS. 5 and 6, the tip portion 128 may include a tip receiver 138 and a tip insert 140. The tip receiver 138 may be removably affixed, directly or indirectly, to the shaft portion 126 proximate the apex 136 of the shaft portion 126 using a threaded connection or any other suitable non-permanent connection method, including, but not limited to, press fit or clamping. As shown, for example, in FIG. 5, the shaft portion 126 may be externally threaded proximate the apex 136 of the shaft portion 126, and the tip receiver 138 may include internal threads configured to mate with the external threads formed on the shaft portion 126. Engagement of the threads defined on the shaft portion 126 and the tip receiver 138 joins the tip portion 128 to the shaft portion 126. In other embodiments, the tip receiver 138 may be integrally formed with the shaft portion 126 (e.g., the tip receiver 138 and shaft portion 126 may be formed as a unitary piece by injection molding), or may be adhered, sonically welded, or otherwise relatively permanently affixed to tip portion 128 proximate the apex 136 of the tip portion 128.

The tip receiver 138 may define a tip receiver fluid passage 156. The tip receiver fluid passage 156 may extend from an end portion of the tip receiver 138 positioned proximate the shaft portion 126 to a tip receiver cavity 137. The tip receiver fluid passage 156 enables fluid communication between the fluid passage 150 in the shaft portion 126 and fluid passages defined by the tip insert 140. A flow restrictor 154 or other structure may be positioned within the tip receiver fluid passage 156 to restrict or modify fluid flow between the fluid passage 150 in the shaft portion 126 and the tip receiver fluid passage 156. In some versions of the oral irrigator tip 110, the flow restrictor 154 may be omitted.

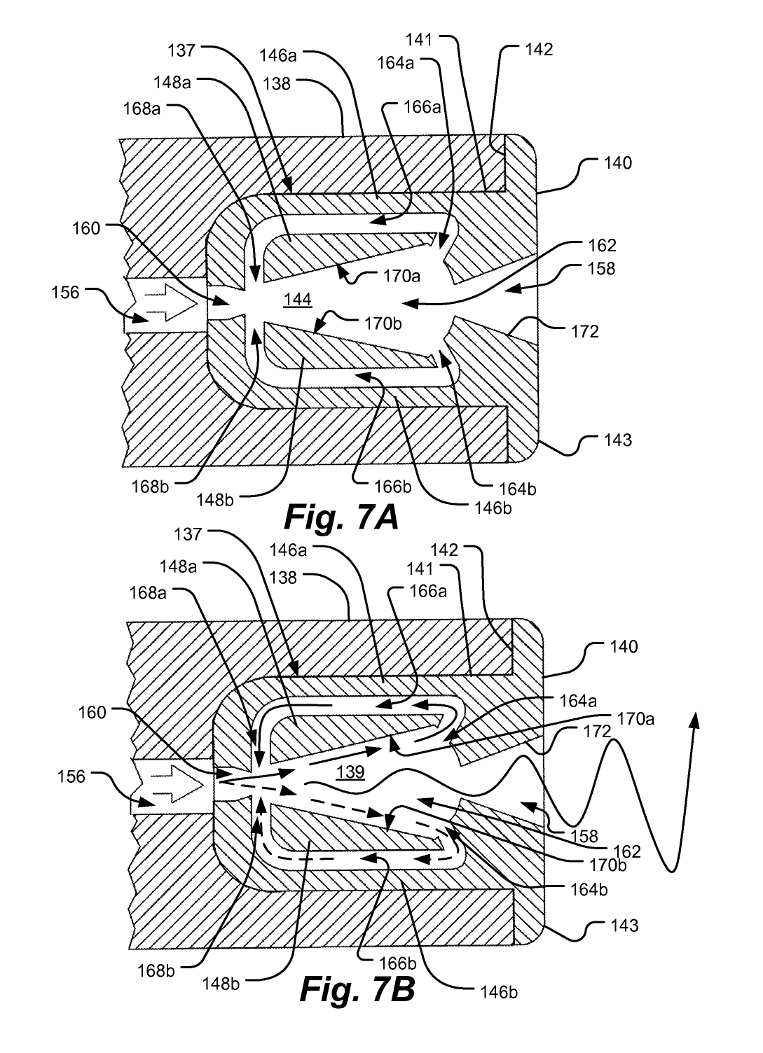

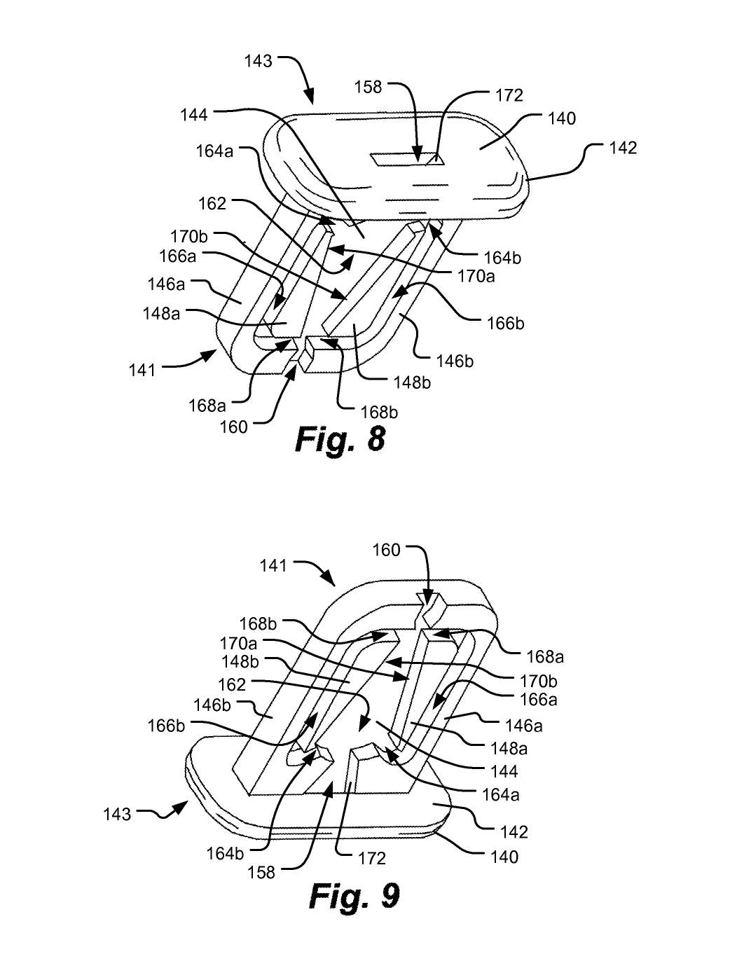

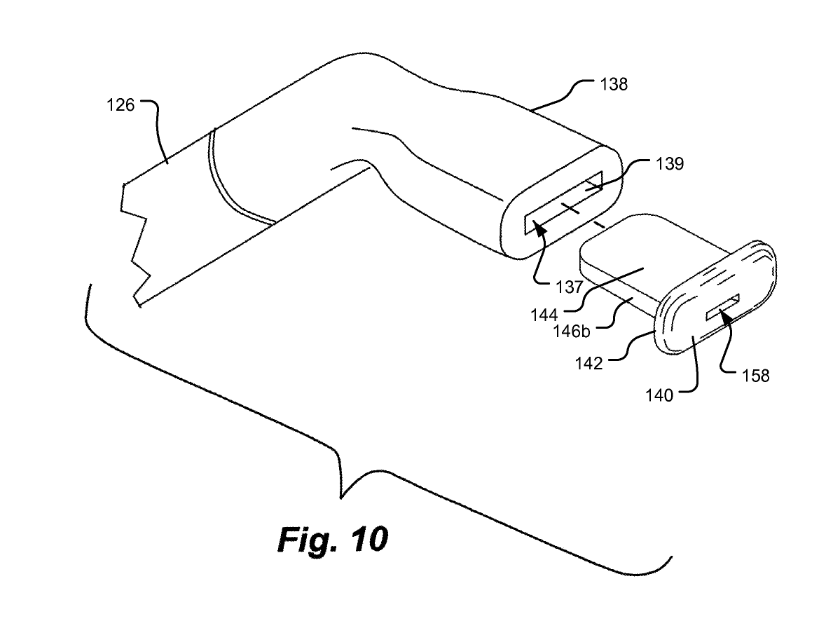

With reference to FIGS. 7A-10, the tip insert 140 may include a generally rectangular main portion 141 defining two rounded corners at a first end and having a flange portion 143 at a second end. The first end of the main portion may be received within the tip receiver cavity 137. The tip receiver cavity 137 may be sized to tightly receive the main portion 141 of the tip insert 140, thus keeping the tip insert 140 joined to the tip receiver 138. In other embodiments, the tip insert 140 may be removably or permanently joined to the tip receiver 138 by other connection means, including, for example, mechanical fasteners, heating, or sonic welding. While the main portion 141 as shown in the figures is a generally rectangular main portion, the main portion 141 may be configured in any suitable shape.

The main portion 141 may further define an inlet 160 of the tip insert 140, at least a portion of the main fluid passage 162, and two side fluid passages 166a/b. The inlet 160, main fluid passage 162, and side fluid passages 164a/b may be formed by defining grooves or other recessed areas in a surface of the main body portion 141 and defining a passage through the flange portion 143 of the tip insert 140. The fluid passages may be encased by an interior wall 139 of the tip receiver 138 and the sidewalls 146a/b and the back wall 144 of the recessed passages of the tip insert 140.

The outlet 158 of the main fluid passage 162 may be defined in the flange portion 143 of the tip insert 140. The flange portion 143 extends normally to the sidewalls of the main portion 141 to form a flange 142 that caps the edges of the tip receiver 138 when the tip insert 140 is placed within the tip receiver cavity 139. The flange 142 prevents over insertion of the tip insert 140 into the tip receiver cavity 137 and provides a surface grip for removal of the tip insert 140 from the tip receiver 138.

The main fluid passage 162 and the two side fluid passages 166a/b may be separated by two identical islands 148a/b. In one embodiment, the islands 148a/b may have four sidewalls with two of the sidewalls adjacent the side fluid passages 166a/b, an angled sidewall 170a/b adjacent the main fluid passage 162, and a short sidewall between one of the sidewalls adjacent a side fluid passage 166a/b and the angled sidewall 170a/b. In other embodiments, the islands 148a/b may be triangular, or may have another polygonal or curved configuration. The islands 148a/b may have flat sidewalls so that fluid may flow around the islands 148a/b with minimal disturbance as fluid is directed from the fluid inlet 153, around the islands 148a/b, and out the fluid outlet 158 of the tip insert 140. The flow of fluid through the tip insert 140 will be further discussed below.

The tip insert fluid passages may be configured to deliver a pulsating stream of fluid from the fluid outlet 158 of the tip portion 128. More particularly and with reference FIGS. 7A, 7B, 8, and 9, the main fluid passage 162 may extend from the inlet 160 of the tip insert 140 positioned proximate the tip receiver fluid passage 156 to the fluid outlet 158 of the tip portion 128. The inlet 160 may be smaller in width and height that the tip receiver fluid passage 156. Proximate the tip receiver fluid passage 156, the inlet 160 of the tip insert 140 initially remains constant in width along its length and then decreases in width along its length until it opens into the main fluid passage 162 adjacent the outlets 168a/b of tip insert side fluid passages 166a/b. From the outlets 168a/b of the side fluid passages 166a/b to the inlets 164a/b of the side fluid passages 166a/b, the main fluid passage 162 gradually increases in width along its length. From the inlets 164a/b of the side fluid passages 166a/b to the outlet 158 of the main fluid passage 162 (i.e., the fluid outlet 158 of the tip portion 128), the main fluid passage 162 initially decreases in width along its length and then increases in width along its length as it transforms into the fluid outlet 158.

The fluid outlet 158 is initially narrower in width than the adjacent area of the main fluid passage 162. The fluid outlet 158 in the flange portion 143 is formed in part by two outlet sidewalls 172 that are angled outward and thus enlarge the width of the fluid outlet 158 from the interface with the main fluid passage 162 until the fluid is emitted from the tip insert 140. This form of increased width further aids in the development of the oscillating fluid waveform that is emitted from the fluid outlet 158 of the tip insert 140.

Each side fluid passage 166a/b initially generally extends from an inlet 164a/b adjacent the fluid outlet 158 in a direction incident to a longitudinal axis defined by the main fluid passage 162. At a select distance from the main fluid passage 162, a curved bend at a generally acute angle is defined from the inlet 164a/b by the side fluid passages 166a/b to change the direction of the side fluid passages 166a/b. From this curved bend, the side fluid passages 166a/b extend in a direction generally parallel a longitudinal axis defined by the main fluid passage 162. Proximate the outlets 168a/b of the side fluid passages 166a/b, another curved bend is defined to again change the direction of the side fluid passages 166a/b. From this second curved bend, each side fluid passage 166a/b generally extends in a direction at a transverse angle relative to a longitudinal axis defined by the main fluid passage 162 until it rejoins the main fluid passage 162 adjacent the inlet 160.

Referring to FIG. 7B, the inlet 160 of the tip insert 140 is configured to create a fluid stream through the center of the main fluid passage 162. As the fluid stream travels away from the inlet 160, fluid is drawn toward the angled sidewall 170a/b of the islands 148a/b lining the main fluid passage 162 due to the Coanda Effect. Fluid traveling along the angled sidewall 170a/b of the islands 148a/b is then diverted into the side fluid passages 166a/b, creating two feedback channels 166a/b to create a positive pressure pulse feedback. More particularly, fluid exiting an outlet 168a of one of the side fluid passages 166a is pushed toward the angled sidewall 146b of the opposite island 148b, into an associated side fluid passage 166b, and then exits the outlet 168b back toward the angled sidewall 146a of the other island 148a. The flow of fluid between the two feedback loops 166a/b continues indefinitely to push the fluid flowing through the main fluid passage 162 back and forth between the sidewalls 170a/b of the islands 148a/b, thus increasing the affinity of the fluid flow thought he main fluid passage 162 alternately along one of the sidewalls 170a and then along the other sidewall 170b.

As shown in FIG. 7B, due to the alternating affinity of the fluid flow through the main fluid passage 162 between the sidewalls 170a/b of the islands 148a/b, fluid may be emitted through the outlet 158 of the tip insert 140 as an oscillating fluid stream. The frequency of oscillation of the fluid emitted from the main fluid passage 162 may be varied by changing the pressure delivered to the inlet 160 of the main fluid passage 162 via the oral irrigator 100. Alternatively, or additionally, the frequency of the fluid oscillation may be varied by changing the distance from the main fluid passage 162 to the inlets 164a/b and outlets 168a/b of the side fluid passages 166a/b. The time that it takes for a fluid particle to leave the inlet 160 of the tip insert 140, travel along the angled sidewall 170a/b of an island 148a/b, and reach the inlet 164a/b of the side fluid passage 166a/b defines the period or “wavelength” of the fluid flow, which is inversely proportional to the frequency in cycles per second or Hertz (Hz). As shown in FIG. 7B, the resulting fluid stream emanating from the outlet 158 of the tip insert 140 forms a sine wave form that fans out to larger amplitudes as the distance from the outlet 158 increases. In this manner an oscillating fluid flow is provided for an improved and beneficial oral cleaning effect.

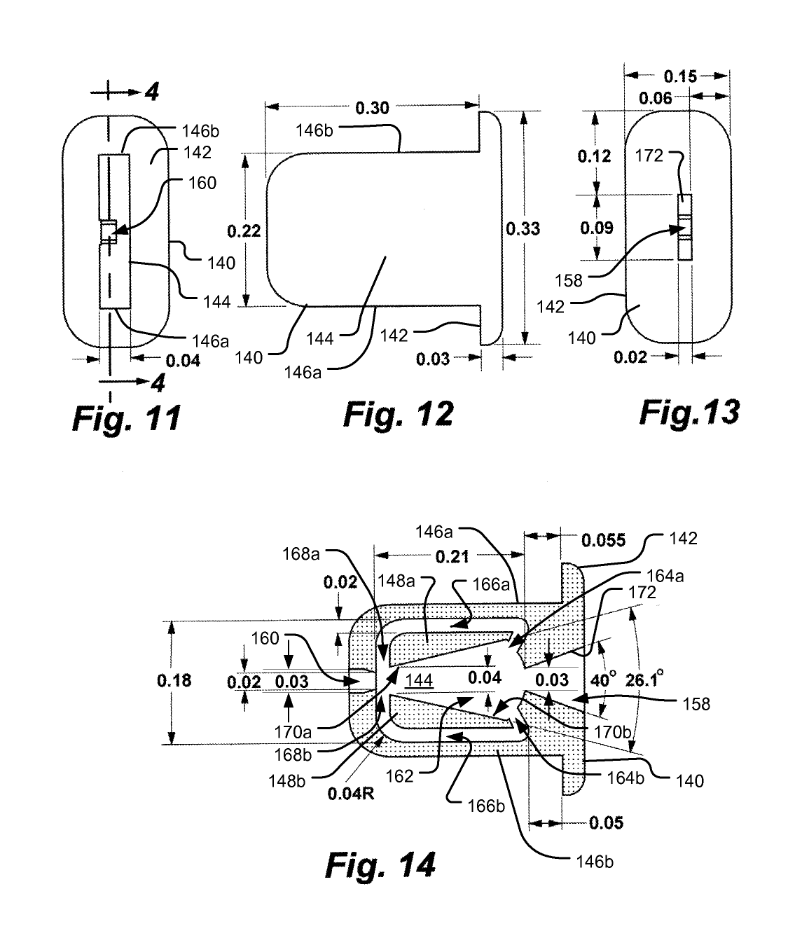

FIGS. 11-14 show various dimensions, in inches and degrees, of an exemplary implementation of the main fluid passage 162, the side fluid passages 166a/b, the main body 141, and the flange portion 143 of the tip insert 140. In the exemplary embodiment with the dimensions shown in FIGS. 11-14, the main fluid passage 162 and side fluid passages 166a/b of the tip insert 140 allow for the creation of a bi-stable fluid amplifier so that fluid that is delivered to the inlet 160 of the main fluid passage 162 at a pressure of approximately 90 p.s.i. and exits the outlet 158 of the main fluid passage 162 at a frequency of approximately 35,000 cycles per minute at a pressure of 60 p.s.i.

All directional references (e.g., upper, lower, upward, downward, left, right, leftward, rightward, top, bottom, above, below, inner, outer, vertical, horizontal, clockwise, and counterclockwise) are only used for identification purposes to aid the reader's understanding of the example of the invention, and do not create limitations, particularly as to the position, orientation, or use of the invention unless specifically set forth in the claims. Joinder references (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

The above specification, examples, and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. An oral irrigator tip comprising
a shaft portion defining a fluid passage;
a tip portion defining
a main fluid passage in fluid communication with the fluid passage defined in the shaft portion,
a first side fluid passage on a first side of the main fluid passage having a first inlet and a first outlet both in fluid communication with the main fluid passage, and
a second side fluid passage on a second side of the main fluid passage having a second inlet and a second outlet both in fluid communication with the main fluid passage;
wherein at least a portion of the fluid stream entering the main fluid passage through the shaft portion is diverted to the first and second side fluid passages so as to deliver an oscillating fluid stream from the oral irrigator tip.

2. The oral irrigator tip of claim 1, wherein the tip portion comprises a tip receiver and a tip insert and the tip receiver defines a cavity configured to receive at least a portion of the tip insert.

3. The oral irrigator tip of claim 2, wherein
the tip receiver further defines a fluid passage positioned between the fluid passage in the shaft portion and the tip portion;
the tip insert defines an inlet, an outlet, the main fluid passage, the first side fluid passage, and the second side fluid passage; and
the fluid passage of the tip receiver is in fluid communication with the fluid passage of the shaft portion and the inlet of the tip insert.

4. The oral irrigator tip of claim 1, wherein the tip portion further comprises a first island and a second island and the first side fluid passage is defined in part by a first wall of the first island and the second side fluid passage is defined in part by a second wall of the second island.

5. The oral irrigator tip of claim 1, wherein the tip portion further comprises a first island and a second island and the first island forms a first angled sidewall adjacent the main fluid passage and the second island forms a second angled sidewall adjacent the main fluid passage.

6. The oral irrigator tip of claim 7, wherein at least a portion of the fluid stream entering the oral irrigator tip through the shaft portion is alternately drawn to flow adjacent the first angled sidewall of the first island and the second angled sidewall of the second island.

7. The oral irrigator tip of claim 1, wherein the tip portion is configured to deliver the oscillating fluid stream from the tip portion at a pressure of approximately 60 pounds per square inch and at a frequency of 35,000 cycles per minutes when receiving fluid from the fluid passage of the shaft portion at a pressure of approximately 90 pounds per square inch.

8. The oral irrigator tip of claim 1, wherein the oscillating fluid stream defines a sine wave.

9. An oral irrigator tip comprising
a shaft portion defining a fluid passage;
a tip portion defining
a main fluid passage in fluid communication with the fluid passage defined in the shaft portion;
a first island on a first side of the main fluid passage; and
a second island on a second side of the main fluid passage; wherein
the first island defines a first angled sidewall adjacent the main fluid passage;
the second island defines a second angled sidewall adjacent the main fluid passage; and
at least a portion of a fluid stream entering the tip portion from the fluid passage of the shaft portion is caused to circulate around the first island and the second island.

10. The oral irrigator tip of claim 9, wherein the tip portion further comprises
a tip receiver; and
a tip insert, wherein
the tip receiver defines a cavity configured to receive at least a portion of the tip insert.

11. The oral irrigator tip of claim 10, wherein the main fluid passage is formed as a recessed area in the tip insert and the first island and the second island are formed as unrecessed areas on the tip insert surrounded by recessed areas including, in part, the main fluid passage.

12. The oral irrigator tip of claim 11, wherein an inner wall of the tip receiver defining the cavity further defines a wall bounding the main fluid passage.

13. The oral irrigator tip of claim 9, wherein
the tip insert further defines a first side fluid passage as a part of the recessed areas bounding a portion of the first island; and
the tip insert further defines a second side fluid passage as a part of the recessed areas bounding a portion of the second island.

14. The oral irrigator tip of claim 13, wherein at least a portion of fluid entering from the fluid passage of the shaft portion is diverted into the first and second side fluid passages.

15. The oral irrigator tip of claim 9, wherein the first and second islands are substantially identical in shape.

16. The oral irrigator tip of claim 9, wherein at least a portion of fluid entering the tip portion from the fluid passage of the shaft portion is drawn to flow adjacent the first and second angled sidewalls by the Coanda effect.

17. The oral irrigator tip of claim 9, wherein the first and second islands are configured interact with the fluid stream to deliver an oscillating fluid stream through an outlet of the tip.

18. The oral irrigator tip of claim 17, wherein the oscillating fluid stream defines a sine wave and an amplitude of the wave increases as a distance from the outlet of the tip increases.

19. The oral irrigator tip of claim 17, wherein the frequency of the oscillating fluid stream can be modified by changing a length of the first angled sidewall and a length of the second angled sidewall.

20. An oral irrigator tip insert comprising
an inlet;
a main channel in fluid communication with the inlet;
a structure configured to cause a Coanda effect on fluid flow through the main channel;
a pair of feedback loops that divert fluid from the main channel at a first end and redirect the diverted fluid into the main channel at a second end; and
an outlet through which oscillating fluid flow exits the tip insert.
